(19) United States
(12) Patent Application Publication
(10) Pub. No.: US 2011/0061635 A1
(43) Pub. Date: Mar. 17, 2011

(54) Crankcase Ventilation Device for Internal Combustion Engines

(76) Inventor: Peter Bukhenik, Stoughton, MA (US)

(21) Appl. No.: 12/560,405

(22) Filed: Sep. 15, 2009

(51) Int. Cl. F02B 25/06

(52) U.S. Cl. 123/573

(57) ABSTRACT

A conduit filter for an internal combustion engine, such as a diesel engine, comprises: a tubular conduit configured to enclose a stream of crankcase ventilation from the engine; and one or more vanes attached to an interior conduit surface of the tubular conduit, the one or more vanes protruding into the stream of crankcase ventilation to stimulate turbulence in the stream of crankcase ventilation so as to facilitate the deposition of oil from the stream of crankcase ventilation onto the interior conduit surface and onto surfaces of the one or more vanes.

### FIELD OF THE INVENTION

The present invention relates to internal combustion engines and, more particularly, to a device for filtering ventilation gas emission from the crankcase of a diesel engine.

### BACKGROUND OF THE INVENTION

Modern internal combustion engines, such as diesel engines, are configured to provide an exhaust pathway to relieve the buildup of fumes in the crankcase. FIG. 1 is a diagrammatical side view of an engine 10 and radiator 11. A crankcase ventilation tube 13 is shown attached to a ventilation port (not shown) on a crankshaft cover 17 of the engine 10, where the crankcase ventilation tube 13 typically has an open end directed generally at the ground.

Because some of the crankcase oil provided in an oil pan 15 is mixed in with the crankcase fumes, engine oil is also vented to the atmosphere along with the exhaust gas In the process of emitting the crankcase fumes via the crankcase ventilation tube 13. As the engine 10 continues to operate, some of this crankcase oil accumulates on the surfaces of the engine 10, and some is dispersed into the atmosphere or is deposited on the ground.

What is needed is a device and method for reducing the amount of crankcase oil emitted to the atmosphere while still providing adequate ventilation for the crankcase of an internal combustion engine.

### BRIEF SUMMARY OF THE INVENTION

In one aspect of the present invention, a conduit filter for an internal combustion engine comprises: a tubular conduit configured to enclose a stream of crankcase ventilation from the engine; and one or more vanes attached to an interior conduit surface of the tubular conduit, the one or more vanes protruding into the stream of crankcase ventilation to stimulate turbulence in the stream of crankcase ventilation so as to facilitate the deposition of oil from the stream of crankcase ventilation onto the interior conduit surface and onto surfaces of the one or more vanes.

In another aspect of the present invention, a conduit filter device suitable for use at a crankcase ventilation port on an internal combustion engine comprises: an elbow configured for attachment to the crankcase ventilation port; a conduit filter attachable to the elbow such that a longitudinal axis of the conduit filter is maintained in a substantially vertical orientation when the conduit filter is attached to the elbow, the elbow being attached to the crankcase ventilation port; and a transitional conduit attachable to the conduit filter, the transitional conduit including a first transitional portion and a second transitional portion, the second transitional portion having a longitudinal axis oriented at an angle to a longitudinal axis of the first transitional portion, the first transitional portion longitudinal axis oriented at an angle to the conduit filter longitudinal axis when the transitional conduit is attached to the conduit filter.

In yet another aspect of the present invention, a method for filtering oil from the crankcase cover ventilation exhaust of an internal combustion engine comprises: removing, from a ventilation port on the crankcase cover, a crankcase ventilation component provided with the engine; attaching an input end of a conduit filter device to the ventilation port, the conduit filter device configured to stimulate turbulence in ventilation exhaust passing through the conduit filter device, the turbulence functioning to facilitate the deposition of oil droplets from the ventilation exhaust onto an interior surface of the conduit filter device; and attaching at least a portion of the crankcase ventilation component to an output end of the conduit filter assembly.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

FIG. 1 is a diagrammatical illustration of a side view of a typical internal combustion engine showing a conventional crankcase ventilation tube, in accordance with the prior art;

FIG. 2 is a diagrammatical illustration showing a crankcase ventilation device emplaced on the side of an engine, in accordance with an aspect of the present invention;

FIG. 3 is a detail diagrammatical view of the crankcase ventilation device of FIG. 2 showing a conduit filter attached to the crankshaft cover of the engine with mounting components;

FIG. 4 is a detail diagrammatical side view of the conduit filter of FIG. 3;

FIG. 5 is a diagrammatical cross sectional view of the conduit filter of FIG. 3 showing two sets of vanes angled against the direction of air flow to increase turbulence in the ventilation gas emitted from the engine;

FIG. 6 is a diagrammatical isometrical view of the conduit filter of FIG. 5 in an opened configuration to show interior placement of the angled vanes;

FIG. 7 is a diagrammatical cross sectional view of an alternate embodiment of a conduit filter, in accordance with the present invention, comprising one set of vanes angled against the direction of air flow and another set of vanes angled toward the direction of air flow;

FIG. 8 is a diagrammatical cross sectional view of still another alternate embodiment of a conduit filter, in accordance with the present invention, comprising shorter vanes than the vanes of FIG. 5;

FIG. 9 is a diagrammatical cross sectional view of yet another embodiment of a conduit filter, in accordance with the present invention, comprising only one set of vanes;

FIG. 10 is a diagrammatical cross sectional view of another embodiment of a conduit filter, in accordance with the present invention, comprising two sets of curved vanes;

FIG. 11 is a diagrammatical cross sectional view of another embodiment of a conduit filter, in accordance with the present invention, comprising two sets of vanes having arcuate gaps at the interior surface of the conduit filter; and,

FIG. 12 is a diagrammatical cross sectional view of an alternate embodiment of a conduit filter, in accordance with the present invention, comprising two sets of vanes having through holes in the vanes.

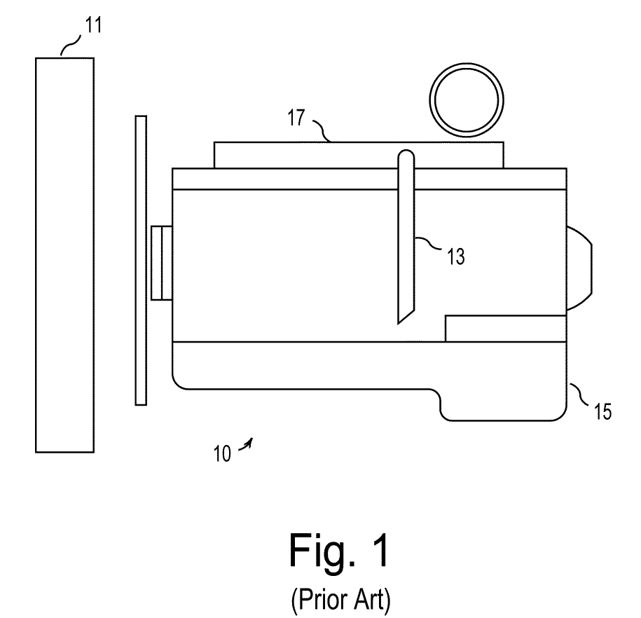

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

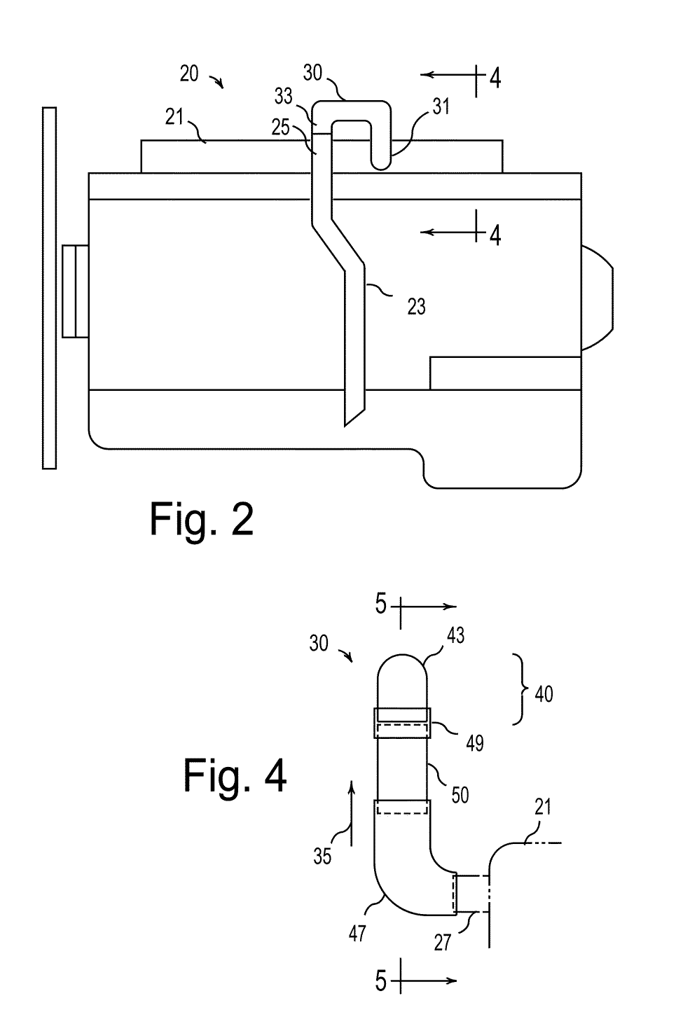

There is shown in FIG. 2 an exemplary embodiment of a conduit filter device 30 having a first end 31 attached to a crankshaft cover 21 of an internal combustion engine, such as a diesel engine 20, in accordance with the present invention. A modified crankcase ventilation component 23 may be attached to a second end 33 of the conduit filter device 30. The modified crankcase ventilation component 23 may be fabricated from a crankcase ventilation component (not shown) originally provided for or supplied with the diesel engine 20 and previously attached to the crankshaft cover 21 before the conduit filter device 30 was installed. In an exemplary embodiment, a suitable section of the (unmodified) crankcase ventilation component configured for attachment to the crankcase cover ventilation port is removed, and the remaining portion of the crankcase ventilation component may be used as the modified crankcase ventilation component 23.

In the example shown, the original crankcase ventilation component has been reworked to form the modified crankcase ventilation component 23 by removing the original, angled tubular end that mated with the ventilation port. After removal of the angled tubular end, a straight section 25 is available for attachment to the second end 33 of the conduit filter device 30. In an alternative exemplary embodiment, any suitable tubular component may be attached to the second end 33 of the conduit filter device 30 such that crankcase ventilation exhaust passing through the conduit filter device 30 is directed generally downward as shown.

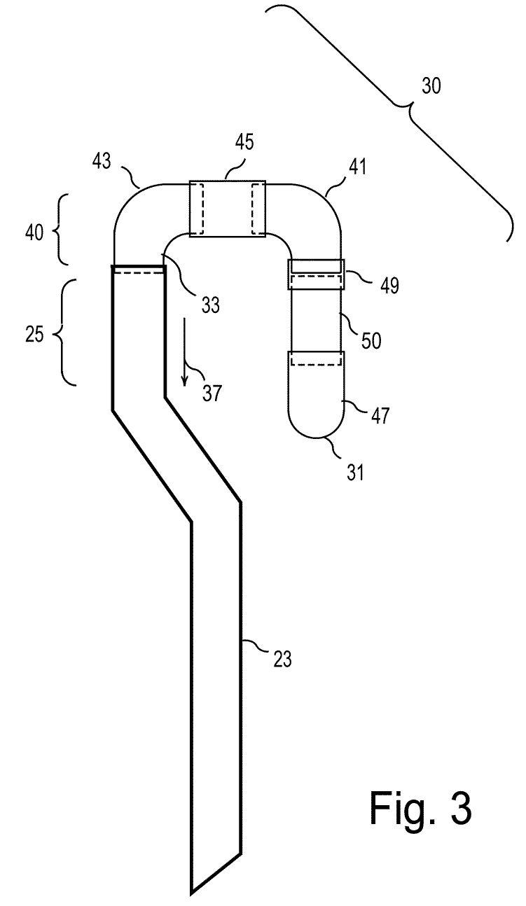

With reference to the detail diagrammatical view of FIG. 3 and the diagrammatical partial side view of FIG. 4, the conduit filter device 30 comprises a conduit filter 50 attached to a ventilation port 27 on the crankshaft cover 21 by means of an elbow 47. The conduit filter 50 is configured to enclose the stream of crankcase ventilation from the diesel engine 20, and may have approximately the same diameter as the crankcase ventilation component originally provided with the diesel engine 20. The elbow 47 may be formed from a metal compound, or from an oil-resistant, heat-resistant elastomeric material, such as plastic or the synthetic rubber commonly found in radiator hoses, for example.

The elbow 47 may be secured to the conduit filter 50 and to the ventilation port 27 by means of hose clamps (not shown, for clarity of illustration), or by using other mechanical fastening methods known in the art, including but not limited to, welding, brazing, bonding, and swaging. In an exemplary embodiment, the elastomeric material can withstand temperatures of at least 150° F. The elbow 47 provides an approximately 90° bend and, as such, functions to place the conduit filter 50 in a non-horizontal position, such as in the substantially vertical orientation shown. Accordingly, the stream of crankcase ventilation is redirected to a vertical flow direction in the conduit filter 50, as indicated by arrow 35, after passing through the elbow 47.

The conduit filter device 30 further comprises a transitional conduit assembly 40 attached to the conduit filter 50 and to the modified crankcase ventilation component 23, generally as shown. The attachments at either or both ends of the conduit filter 50 may be made with hose clamps (not shown, for clarity of illustration), or may be mechanically attached as described above for the elbow 47. The transitional conduit assembly 40 functions to further change the direction of the fluid stream of crankcase ventilation, from the substantially vertical direction in the conduit filter 50 to a generally downward direction in the modified crankcase ventilation component 23, for expulsion of filtered gas towards the ground.

In the configuration shown, the transitional conduit assembly 40 may comprise a first transitional segment 41 configured to redirect the crankcase ventilation exhaust from a substantially upwardly vertical direction to a substantially horizontal direction, and a second transitional segment 43 configured to redirect the crankcase ventilation exhaust from the substantially horizontal direction to a substantially downwardly vertical direction, indicated by arrow 37. The transitional conduit assembly 40 may comprise a three-piece assembly with a transitional connector 45 for attaching the first transitional segment 41 to the second transitional segment 43.

In an exemplary embodiment, the first transitional segment 41 and the second transitional segment 43 may be formed from metal, and the transitional connector 45 may be formed from an elastomeric material. Attachment of the first transitional segment 41 and the second transitional segment 43 to the transitional connector 45 may be accomplished by adhesion, or by clamping with hose clamps (not shown), as is known in the relevant art. The transitional conduit assembly 40 may be attached to the conduit filter 50 by a connecting sleeve 49 formed from an elastomeric material. Alternatively, the transitional conduit assembly 40 may be formed as or fabricated into a single integral unit or unitary component (not shown), comprising metal and/or elastomeric material, for example, to facilitate assembly to the conduit filter 50 and to the modified crankcase ventilation component 23, and to lower manufacturing costs.

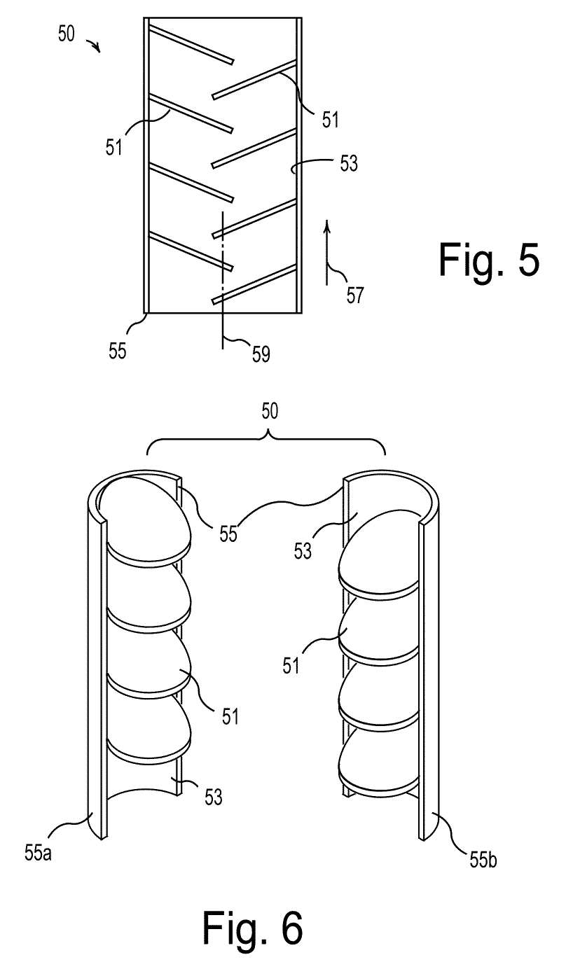

Generally, the internal configuration of the conduit filter 50 is specified to stimulate turbulence in the crankcase ventilation exhaust passing to the atmosphere without impeding the flow of the exhaust. As seen in the cross-sectional view of FIG. 5, and in the isometric diagram of FIG. 6, a first exemplary embodiment of the conduit filter 50 comprises a plurality of internal vanes 51 attached to an interior surface 53 of a tubular conduit 55 such that the specified turbulence is created in the stream of crankcase ventilation passing upward through the conduit filter 50, as indicated by arrow 57. In an exemplary embodiment, the tubular conduit 55 may be approximately six to twenty centimeters in length and approximately two to five centimeters in diameter. It can be appreciated by one skilled in the art that these dimensions can be varied to accommodate the physical dimensions of a particular internal combustion engine and ventilation port specified for emplacement of the conduit filter device 30.

Although eight vanes 51 are shown in the illustration, it should be understood that more or fewer vanes 51 may be used in a particular application, depending upon the rate of the air flow conveyed by the conduit filter 50 and the amount of turbulence to be introduced into the stream of crankcase ventilation. Alternatively, the sizes of the vanes may vary from one end of the conduit filter 50 to the other. The vanes 51 may be formed of metal or plastic, and may be arranged in essentially any pattern that creates or stimulates turbulence in the stream of crankcase ventilation so as to facilitate the deposition of oil droplets from the crankcase ventilation exhaust onto the interior conduit surface 53 and onto the surfaces of the vanes 51.

In an exemplary embodiment, the tubular conduit 55 may be fabricated from a first conduit section 55a and a second conduit section 55b to aid in the attachment of the vanes 51 to the interior surface 53 during fabrication. The first conduit section 55a and the second conduit section 55b may match along an interface that is approximately parallel to a longitudinal axis 59 of the tubular conduit 55. The first conduit section 55a and the second conduit section 55b may thus comprise approximately equal sectional halves (as shown) of the tubular conduit 55, or may alternatively be configured as unequal sections (not shown).

In the particular embodiment shown, the vanes 51 are angled into the direction of flow of the stream of crankcase ventilation, and extend up to or past the longitudinal axis 59 such that an overlap of vanes 51 is provided, as “seen” by the air flow inside the conduit filter 50. As the deposited oil droplets collect on the interior conduit surface 53 and on the surfaces of the vanes 51, aggregations of oil droplets merge to form oil drops which migrate downward toward the elbow 47 due to the force of gravity. The oil drops subsequently flow through the elbow 47, in response to the force of gravity, and return into the crankcase of the diesel engine 20 rather than being expelled into the atmosphere. The consumption of engine oil in the diesel engine 20 is thereby reduced. It has been observed that, by using a conduit filter device 30 in accordance with the present invention, the reduction in oil consumption may be on the order of one gallon of oil saved for every 1000 miles of diesel engine operation.

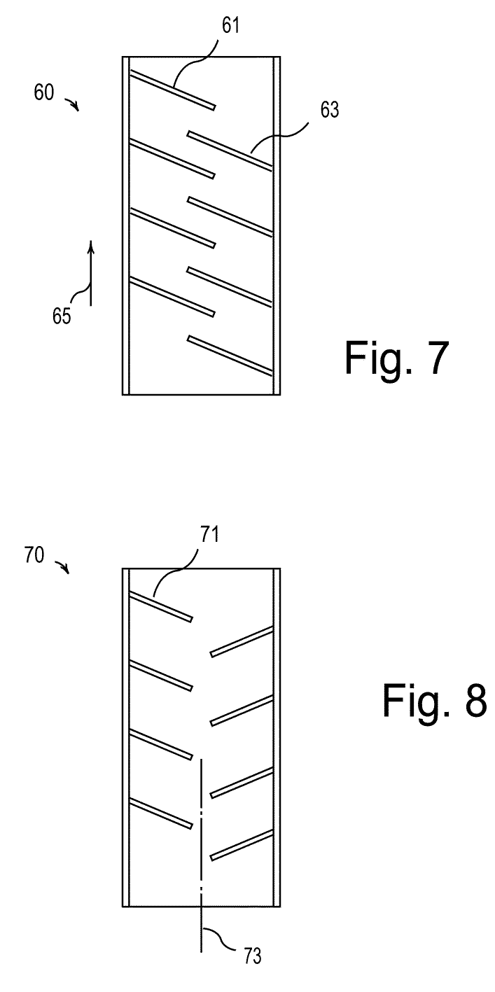

In another exemplary embodiment, shown in FIG. 7, a conduit filter 60 comprises a first plurality of vanes 61 angled against the direction of air flow, indicated by arrow 65, and a second plurality of vanes 63 angled toward the direction of air flow. In still another exemplary embodiment, shown in FIG. 8, a conduit filter 70 comprises a plurality of vanes 71 angled against the direction of air flow, where the vanes 71 do not extend past a longitudinal axis 73 of the conduit filter 70 and are thus shorter than the vanes 51 in FIG. 5, above. Accordingly, there may be essentially no overlap of vanes 71 as “seen” by the air flow inside the conduit filter 70.

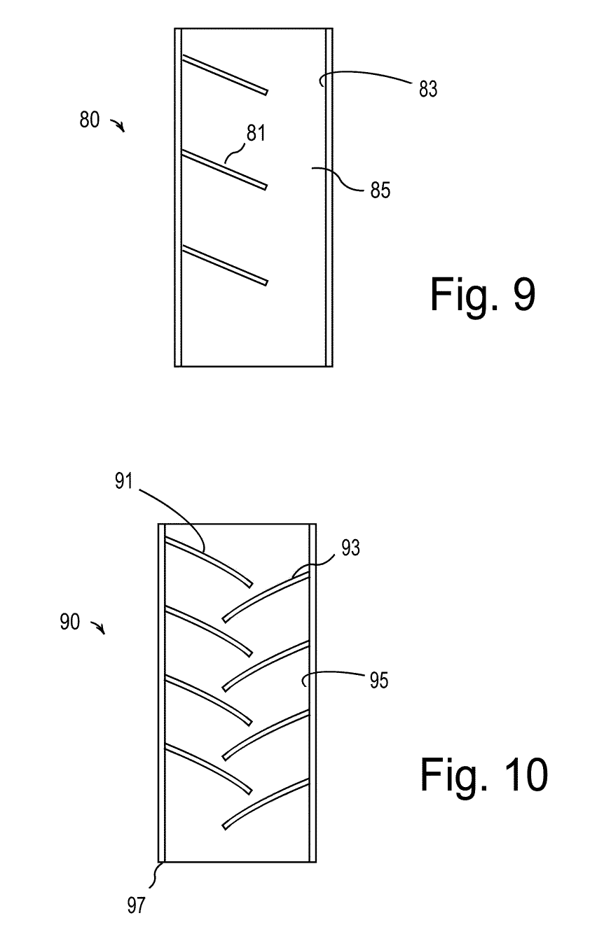

In still another exemplary embodiment, shown in FIG. 9, a conduit filter 80 comprises a plurality of vanes 81 on only one side of the interior surface 83 of the conduit filter 80. The plurality of vanes 81 may be angled against the direction of air flow, generally as shown, or may be angled in the direction of flow (not shown). In another exemplary embodiment, shown in FIG. 10, a conduit filter 80 comprises a plurality of curved vanes 91 and curved vanes 93 (i.e., wherein each vane may be formed with a cylindrical surface, a convex surface, or a concave surface, for example) on an interior surface 95 of a tubular conduit 97. The vane curvature may be downward, against the direction of air flow, as shown, or upward, toward the direction of air flow (not shown). The orientations of the curved vanes 91 and 93 are here shown as angled against the direction of air flow, indicated by arrow 99.

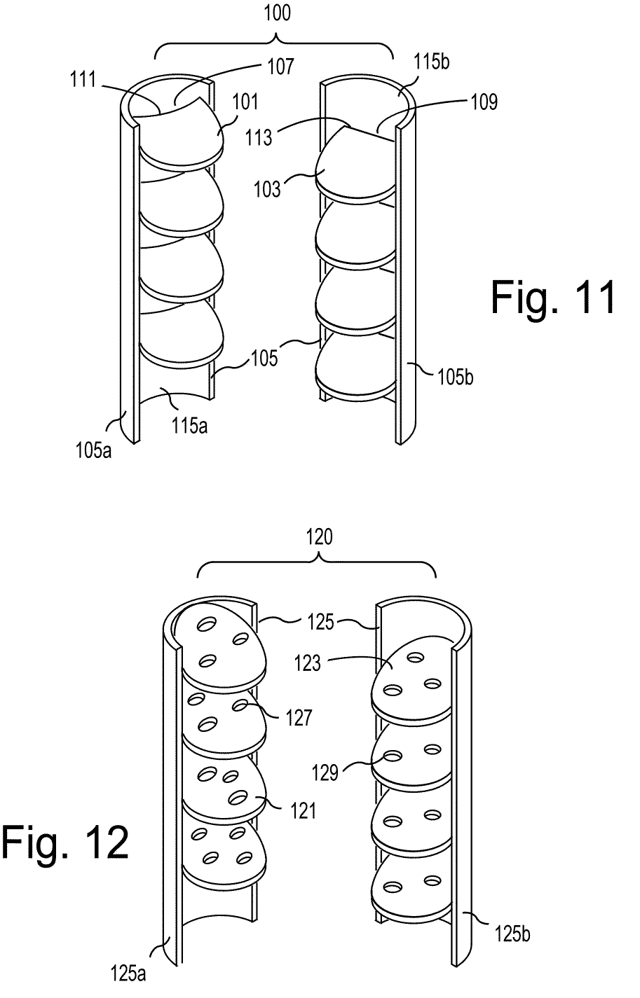

As seen in the isometric diagram of FIG. 11 (partially exploded for clarity of illustration), an alternative exemplary embodiment of a conduit filter 100 may comprise a plurality of modified vanes 101, shown here attached to a first conduit section 105a of a tubular conduit 105, or a plurality of modified vanes 103, shown here attached to a second conduit section 105b of the tubular conduit 105. It should be understood that, although both the modified vanes 101 and the modified vanes 103 are shown in the tubular conduit 105 for purpose of illustration, the conduit filter 100 will typically comprise only one style of the two modified vane configurations shown.

The modified vanes 101 and 103 are configured to provide corresponding arcuate gaps 107 and 109 between the respective modified vanes 101 and 103 and the interior surfaces 115a and 115b of the first conduit section 105a and the second conduit section 105b. The modified vanes 101 may include a curved edge 111 to form the arcuate gap 107, and the modified vanes 103 may include a flat edge 113 to form the arcuate gap 109. The arcuate gaps 107 and 109 are configured to provide bypass air passageways to create further turbulence in the stream of crankcase ventilation.

In still another exemplary embodiment, shown in the isometric diagram of FIG. 12 (partially exploded for clarity of illustration), a conduit filter 120 may comprise a plurality of vented vanes 121, here shown attached to a first section 125a of a tubular conduit 125, or plurality of vented vanes 123, here shown attached to a second section 125b of the tubular conduit 125. It should be understood that, although both the vented vanes 121 and the vented vanes 123 are shown in the tubular conduit 125 for purpose of illustration, the conduit filter 120 will typically comprise only one of the two vented vane configurations shown. The vented vanes 121 include through holes 127 spaced randomly in the respective vented vanes 121, whereas the vented vanes 123 include through holes 129 spaced at regular intervals to provide bypass air passageways. The number of through holes is shown as three or four, for convenience of illustration, but a greater or lesser number of holes can be specified for the vented vanes 121 and 123, depending on application.

Accordingly, the through holes 129 may “line up” from one vented vane 123 to another vented vane 123. In comparison, the through holes 127 may not “line up” from one vented vane 121 to another vented vane 121. It can be appreciated by one skilled in the art that the physical characteristics of the air flow turbulence in the conduit filter 120 may differ from the characteristics of the air flow turbulence in the conduit filter 100. Thus, the configuration of the conduit filter 120 may be more suitable for a particular application than the configuration of the conduit filter 100

It should be understood that, while the conduit filters 50, 100, and 120 comprise vanes having the “angled against the direction of air flow” orientation and the “overlapping” configuration as shown in the cross sectional diagrammatical view of FIG. 5, a conduit filter configured and fabricated in accordance with the present invention will also include configurations of the conduit filters 50, 100, and 120 comprising vanes having alternative cross sectional orientations and configurations as shown in FIGS. 7 through 10.

It is also to be understood that the description herein is exemplary of the invention only and is intended to provide an overview for the understanding of the nature and character of the invention as it is defined by the claims. The accompanying drawings are included to provide a further understanding of various features and embodiments of the method and apparatus of the invention which, together with their description serve to explain the principles and operation of the invention. Thus, while the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. A conduit filter suitable for use in an internal combustion engine, said conduit filter comprising:
a tubular conduit configured to enclose a stream of crankcase ventilation from the engine; and
one or more vanes attached to an interior conduit surface of said tubular conduit, said one or more vanes protruding into said stream of crankcase ventilation to stimulate turbulence in said stream of crankcase ventilation so as to facilitate the deposition of oil from said stream of crankcase ventilation onto said interior conduit surface and onto surfaces of said one or more vanes.

2. The conduit filter of claim 1 wherein said one or more vanes are oriented at an angle to the direction of flow of said stream of crankcase ventilation.

3. The conduit filter of claim 1 wherein at least one of said one or more vanes extends from said interior conduit surface up to or past a longitudinal axis of said tubular conduit.

4. The conduit filter of claim 1 wherein at least one of said one or more vanes is configured to provide an arcuate gap between an edge of said vane and said interior conduit surface.

5. The conduit filter of claim 1 wherein at least one of said one or more vanes comprises at least one through hole.

6. The conduit filter of claim 1 wherein at least one of said one or more vanes comprises one of a flat surface, a cylindrical surface, a concave surface, or a convex surface.

7. A conduit filter device suitable for use at a crankcase ventilation port on an internal combustion engine, said conduit filter device comprising:
an elbow configured for attachment to the crankcase ventilation port;
a conduit filter attachable to said elbow such that a longitudinal axis of said conduit filter is maintained in a substantially vertical orientation when said conduit filter is attached to said elbow, said elbow being attached to the crankcase ventilation port; and
a transitional conduit attachable to said conduit filter, said transitional conduit including a first transitional portion and a second transitional portion, said second transitional portion having a longitudinal axis oriented at an angle to a longitudinal axis of said first transitional portion, said first transitional portion longitudinal axis oriented at an angle to said conduit filter longitudinal axis when said transitional conduit is attached to said conduit filter.

8. The conduit filter device of claim 7 wherein said transitional conduit comprises a single integral unit.

9. The conduit filter device of claim 7 wherein at least one of said elbow and said transitional conduit comprises either an elastomeric material or a metal compound.

10. The conduit filter device of claim 7 further comprising a modified crankcase ventilation component attached to said transitional conduit, said modified crankcase ventilation component fabricated from a crankcase ventilation component originally provided for the engine.

11. The conduit filter device of claim 7 wherein said conduit filter comprises a tubular conduit, said tubular conduit having one or more vanes attached to an internal surface of said conduit.

12. The conduit filter device of claim 11 wherein said one or more internal vanes extend past a longitudinal axis of said tubular conduit.

13. The conduit filter device of claim 11 wherein said one or more internal vanes is configured to provide bypass air passageways for increasing turbulence in a ventilation air stream passing through said conduit filter.

14. The conduit filter device of claim 11 wherein one of said vanes is oriented at an angle into the direction of flow of said stream of crankcase ventilation and another one of said vanes is oriented at an angle away from the direction of flow of said stream of crankcase ventilation.

15. A method for filtering oil from the crankcase cover ventilation port of an internal combustion engine, said method comprising the steps of:
removing, from a ventilation port on the crankcase cover, a crankcase ventilation component provided for or supplied with the engine;
attaching an input end of a conduit filter device to said ventilation port, said conduit filter device configured to stimulate turbulence in ventilation exhaust passing through said conduit filter device, said turbulence functioning to facilitate the deposition of oil droplets from the ventilation exhaust onto an interior surface of said conduit filter device; and
modifying said crankcase ventilation component for attachment to an output end of said conduit filter assembly.

16. The method of claim 15 wherein said conduit filter device comprises one or more vanes disposed internal to said conduit filter device.

17. The method of claim 16 wherein said one or more vanes are oriented at an angle to the direction of flow of a stream of crankcase ventilation in said conduit filter device.

18. The method of claim 15 wherein said conduit filter device is oriented such that gravity serves to return engine oil from said interior surface of said conduit filter device to the engine crankcase.

19. The method of claim 15 wherein said step of modifying said crankcase ventilation component comprises the step of removing a portion of said crankcase ventilation component.

20. The method of claim 19 wherein said removed portion of said crankcase ventilation component comprises a section of said crankcase ventilation component configured for attachment to the crankcase cover ventilation port.
